(19) United States
(12) Patent Application Publication
(10) Pub. No.: US 2015/0116800 A1
(43) Pub. Date: Apr. 30, 2015

(54) IMAGE PROCESSING APPARATUS

(71) Applicant: ALPS ELECTRIC CO., LTD., Tokyo (JP)

(72) Inventors: Toru Yoshida, Miyagi-ken (JP); Satoshi Terashita, Miyagi-ken (JP); Tsukasa Mizusawa, Miyagi-ken (JP); Yoshihiro Someno, Miyagi-ken (JP)

(21) Appl. No.: 14/525,731

(22) Filed: Oct. 28, 2014

(30) Foreign Application Priority Data
Oct. 31, 2013 (JP) 2013-226795

(51) Int. Cl. G02B 27/01; G03H 1/32; G03H 1/22

(52) U.S. Cl. CPC G02B 27/0103; G03H 1/2205; G03H 1/2286; G03H 1/2294; G03H 1/32; G03H 2001/2213; G02B 2027/0118
USPC 359/9

(57) ABSTRACT

The phase of laser light is modulated by a phase modulating array, and a hologram image is projected on a rotating screen. Light emission of the laser light is driven by PWM modulation so that a light emission period and a non-light emission period following the light emission period are repeated. In a case where the luminance of the hologram image is changed, the duty ratio of the light emission period is changed. In a case where the luminance is significantly reduced, the light emission intensity of the laser light is reduced without changing the duty ratio. Since the duty ratio is not reduced, a light diffusion condition on the rotating screen can be randomized even in a case where the luminance is reduced.

### CLAIM OF PRIORITY

This application claims benefit of priority to Japanese Patent Application No. 2013-226795 filed on Oct. 31, 2013, which is hereby incorporated by reference in its entirety.

### BACKGROUND

1. Field of the Disclosure

The present disclosure relates to an image processing apparatus that generates a hologram image on a rotary screen having a light diffusing function by modulating the phase of laser light.

2. Description of the Related Art

Japanese Unexamined Patent Application Publication No. 2002-90881 discloses a projector apparatus including an image quality improving mechanism.

In this projector apparatus, incident light emitted by a light source is modulated by an LCD and is then supplied to an optical part via a lens system. The optical part, which is driven to rotate by a motor, gives a slight optical path difference to the incident light.

The light flux modulated by the LCD passes through the optical part that is rotating. In this way, occurrence of speckle noise in a projected image is reduced.

According to the projector apparatus described in Japanese Unexamined Patent Application Publication No. 2002-90881, the optical part which the incident light enters is rotated to randomize a speckle noise pattern, and thereby speckle noise superimposed on the projected light is reduced.

However, this method has a disadvantage that when the luminance of the projected light is reduced, the speckle noise cannot be sufficiently reduced.

As described in Japanese Unexamined Patent Application Publication No. 2011-143065, an optical apparatus using a semiconductor laser as a light source adjusts the luminance of projected light by changing a duty ratio which is a ratio of a light-emitting period in a light-emitting cycle.

If the light source emission method described in Japanese Unexamined Patent Application Publication No. 2011-143065 is employed in the projector apparatus described in Japanese Unexamined Patent Application Publication No. 2002-90881, the rotary part is irradiated by the incident light only for a short time in a case where the light emission duty ratio of the light source is reduced. Accordingly, a rotation angle of the rotary part cannot be sufficiently secured during irradiation of the incident light, and therefore the speckle noise cannot be sufficiently randomized. As a result, the speckle noise is likely to remain.

Especially in an in-vehicle projector or the like, luminance of projection light needs to be reduced during running in darkness. As a result, speckle noise becomes more noticeable.

### SUMMARY

An image processing apparatus includes: a laser light source; a screen having a light diffusing function; and a phase modulating array modulating a phase of laser light emitted by the laser light source and forming a hologram image on the screen, the screen being rotated at a certain rotational speed by a motor, light emission of the laser light source being controlled so that a light emission period and a non-light emission period following the light emission period are repeated, luminance of the hologram image being changed by changing a duty ratio of the light emission period, and after the duty ratio is reduced to a predetermined value, the luminance of the hologram image being reduced by reducing light emission intensity of the laser light emitted by the laser light source.

According to the image processing apparatus of the present invention, when the luminance of the hologram image is reduced, the light emission intensity of semiconductor laser is reduced without further reducing the duty ratio of the laser light source. Since the duty ratio is not reduced, it is possible to secure a time in which the hologram image is projected on the screen, and therefore the diffusing function of the screen can be sufficiently randomized. It is therefore possible to suppress an increase in speckle noise.

### BRIEF DESCRIPTION OF THE DRAWINGS

FIG. 1 is an explanatory view showing a state where an image processing apparatus according to an embodiment of the present invention is mounted in a vehicle;

FIG. 2 is an explanatory view showing an example of a display image generated by the image processing apparatus;

FIG. 3 is an exploded perspective view of the image processing apparatus according to the embodiment of the present invention;

FIG. 4 is a plan view showing how main parts of the image processing apparatus according to the embodiment of the present invention are disposed;

FIG. 5 is a partial perspective view showing a configuration of a phase modulating section viewed from the direction indicated by the arrow V of FIG. 4;

FIG. 6 is a partial enlarged plan view showing the configuration of the phase modulating section;

FIG. 7 is a view taken in the direction of the arrow VII of FIG. 6;

FIG. 8 is a partial perspective view showing a configuration of a hologram forming section viewed from the direction of the arrow VIII shown in FIG. 4;

FIG. 9 is a circuit block diagram of the image processing apparatus according to the embodiment of the present invention;

FIGS. 10A to 10D are timing diagrams each showing a light emission operation of a laser light source;

FIG. 11 is a front view showing a hologram image projected on a screen;

FIG. 12 is an explanatory view showing a divided display operation of a hologram image;

FIGS. 13A to 13I are explanatory views each showing a relationship between rotation of the screen and divided display of the hologram image;

FIGS. 14A to 14L are explanatory views each showing a relationship between rotation of the screen and divided display of the hologram image in another embodiment in which the rotational speed of the screen is changed;

FIGS. 15A to 15L are explanatory views each showing a relationship between rotation of the screen and divided display of the hologram image in another embodiment in which the rotational speed of the screen is changed;

FIGS. 16A to 16L are explanatory views each showing a relationship between rotation of the screen and divided display of the hologram image in another embodiment in which the rotational speed of the screen is changed; and

FIG. 17 is an explanatory view showing light emission characteristics of the semiconductor laser.

### DESCRIPTION OF THE EXEMPLARY EMBODIMENTS

### Vehicle Structure

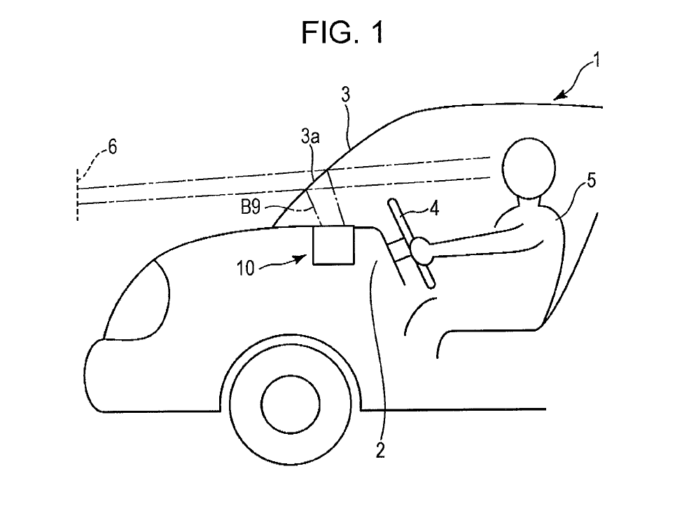

As shown in FIG. 1, an image processing apparatus 10 according to an embodiment of the present invention is embedded in a dashboard 2 on the front side of an automobile 1. The image processing apparatus 10 is used as a so-called head-up display.

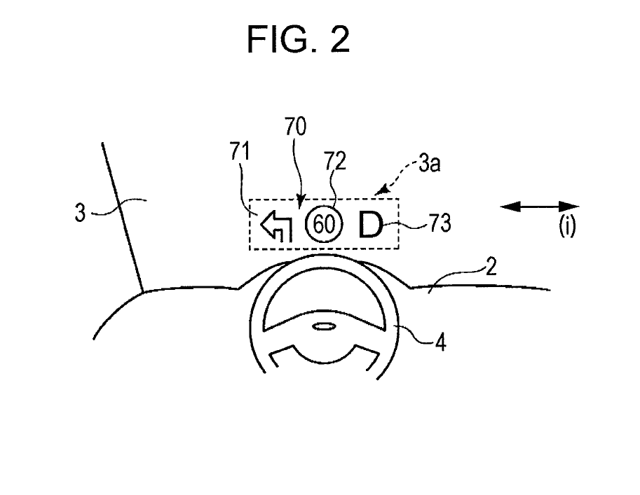

A display image 70 shown in FIG. 2 is projected from the image processing apparatus 10 onto a display region 3a of a windshield 3. Since the display region 3a functions as a semi-reflection surface, the display image 70 projected in the display region 3a is reflected toward a driver 5 by the display region 3a, and a virtual image 6 is formed in front of the windshield 3. The driver 5 sees the virtual image 6 formed before the driver 5, and thus the virtual image 6 appears to the driver 5 as if various kinds of information are displayed above and ahead of a steering wheel 4.

### Overall Configuration of Image Processing Apparatus 10

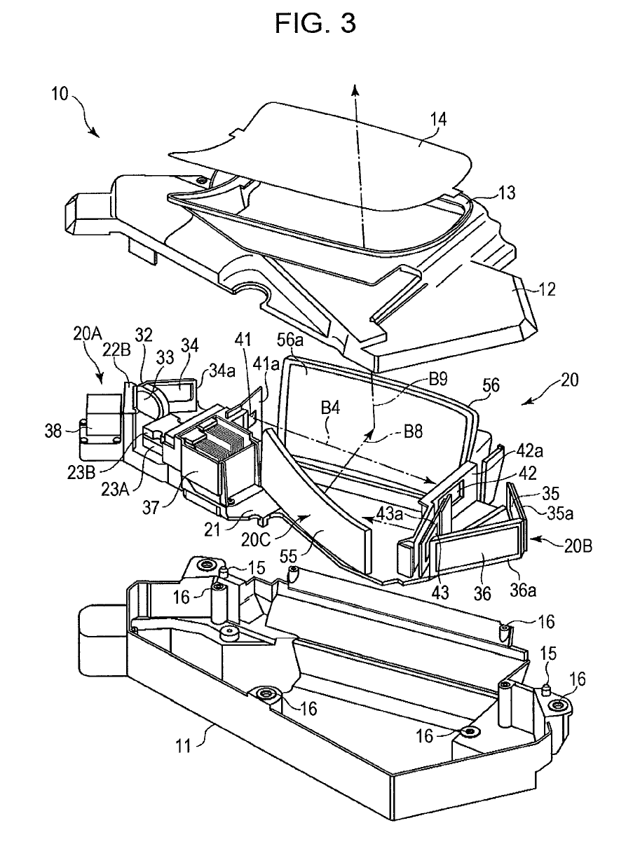

As shown in FIG. 3, a case for the image processing apparatus 10 is separated into a lower case 11 and an upper case 12 that are made of a synthetic resin, and an optical unit 20 is contained in the case. The optical unit 20 has an optical base 21. The optical base 21 is made of aluminum die-cast. The optical base 21 is supported via an elastic member such as an elastomer or a metal spring in the lower case 11. The lower case 11 is fixed onto an interior of the in-vehicle dashboard 2, but since the optical base 21 is supported via the elastic member, it is possible to prevent automotive vibration from directly affecting the optical unit 20. Furthermore, since the optical base 21 is supported by the elastic member, it is possible to reduce an influence of thermal stress on the optical base 21 that is caused by a difference in coefficient of thermal expansion between the case, which is made of the synthetic resin, and the optical base 21, which is made of a metal.

In a state where the optical unit 20 is contained in the case, the positions of the lower case 11 and the upper case 12 are determined by concave-convex fitting using a position-determining pin 15 that is formed so as to be integral with the lower case 11. The lower case 11 has a plurality of female screw holes 16, and fixation screws inserted through the upper case 12 are screwed into the female screw holes 16 to fix the lower case 11 and the upper case 12 to each other.

A projection window 13 is opened in the upper case 12. This projection window 13 is exposed on an upper surface of the dashboard 2, and the display image 70 is projected from the projection window 13 onto the display region 3a of the windshield 3. The projection window 13 is covered with a translucent cover plate 14. The cover plate 14 prevents grit and dust from entering the case. The cover plate 14 is preferably an optical filter that suppresses transmission of light having wavelengths other than the wavelength of display light of a hologram image projected onto the display region 3a so that external light does not directly enter the case from the projection window 13.

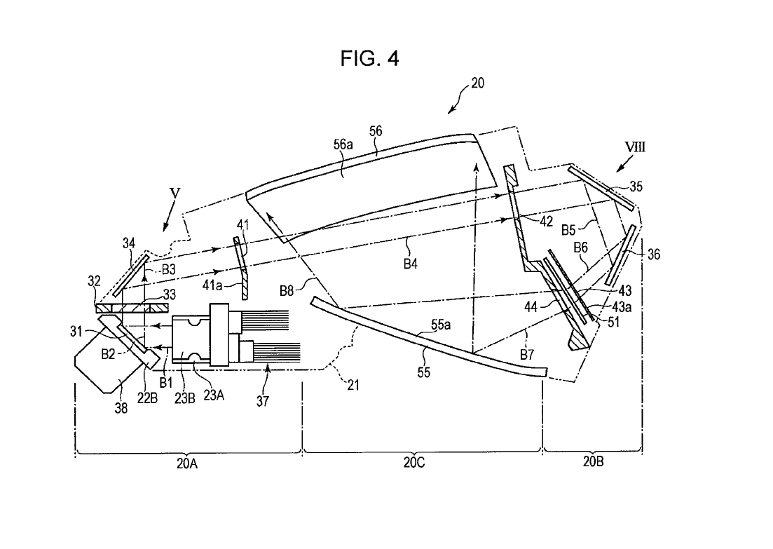

As shown in FIGS. 3 and 4, in the optical unit 20, various kinds of optical parts are mounted on the optical base 21. As shown in FIG. 4, the optical unit 20 is divided into a phase modulating section 20A, a hologram forming section 20B, and a projecting section 20C according to the configuration of the optical parts.

### Phase Modulating Section 20A

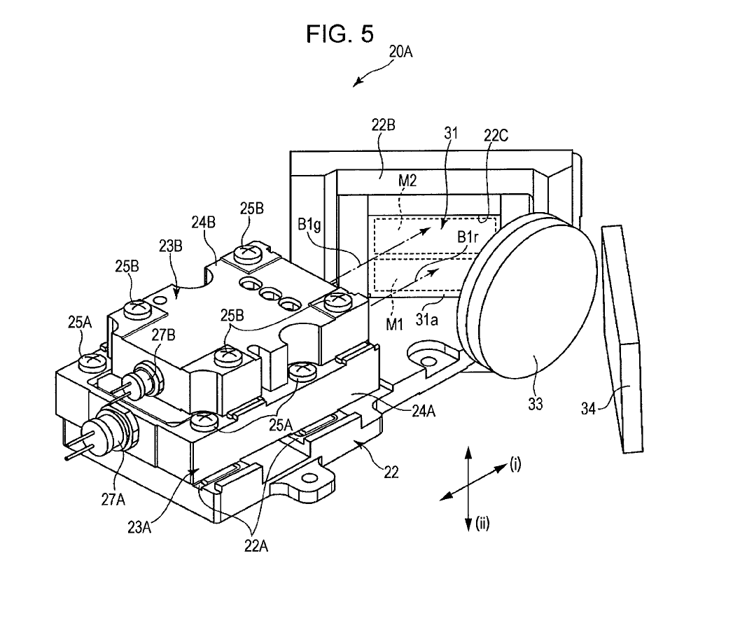

As shown in FIG. 5, a reference base 22 is provided in the phase modulating section 20A. This reference base 22 is fixed on the optical base 21 by a screw.

A first light emitting part 23A and a second light emitting part 23B are disposed on the reference base 22 so as to overlap each other. The first light emitting part 23A has a first position-determining block 24A, and the second light emitting part 23B has a second position-determining block 24B. The first position-determining block 24A is provided on a position-determining reference surface 22A that is formed on the reference base 22, and is fixed on the reference base 22 with the use of a plurality of fixation screws 25A. The second position-determining block 24B is provided on the first position-determining block 24A, and is fixed on the first position-determining block 24A with the use of a plurality of fixation screws 25B.

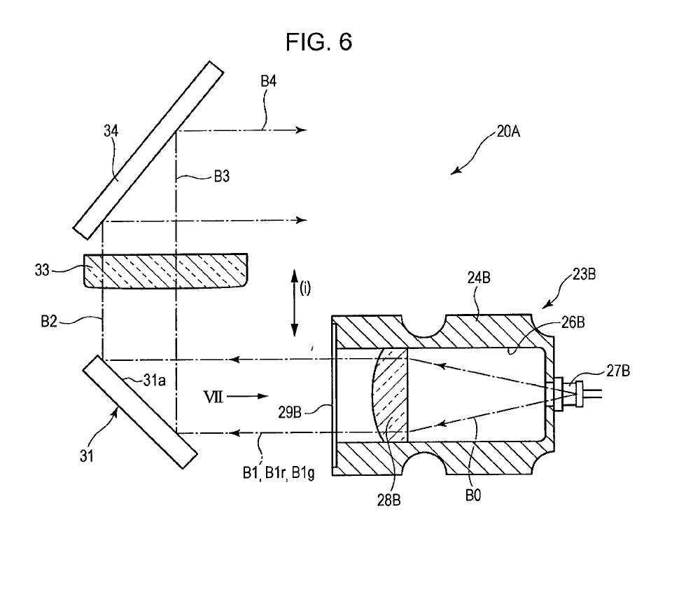

FIG. 6 shows an internal structure of the second position-determining block 24B. A light path 26B is formed in the position-determining block 24B. A second laser unit 27B, which is a laser light source, is attached to a closed side end (an end on the right side of FIG. 6) of the light path 26B. The second laser unit 27B is constituted by a case and a semiconductor laser chip contained in the case. A collimating lens 28B is fixed inside the light path 26B.

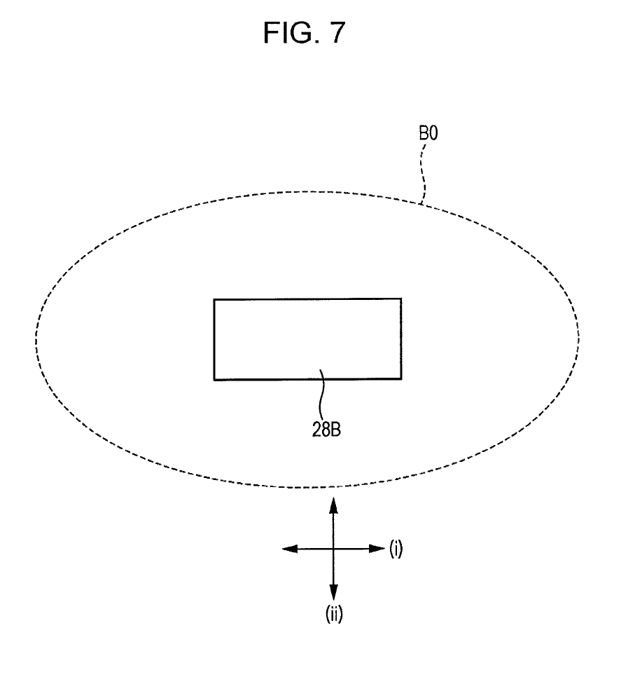

A laser light flux B0 emitted by the second laser unit 27B is diverging light. As shown in FIG. 7, the cross-sectional shape of the laser light flux B0 is an elliptic shape or an oval shape. The long axis of the laser light flux B0 is directed in a horizontal direction (i) that is parallel with the upper surface of the reference base 22, and the short axis of the laser light flux B0 is directed in a vertical direction (ii) that is perpendicular to the upper surface of the reference base 22.

As shown in FIG. 7, the shape of an effective diameter (effective region) of the collimating lens 28B is a rectangle, and longer sides of the rectangle are directed in the horizontal direction (i) in which the long axis of the cross section of the laser light flux B0 is directed. Accordingly, the laser light flux B0 that has passed the collimating lens 28B is converted into a collimated light flux B1 whose cross section is rectangular.

As shown in FIG. 6, an opened end (an opened end on the left side of FIG. 6) of the light path 26B of the position-determining block 24B is blocked by a translucent cover 29B.

The internal structure of the first position-determining block 24A provided in the first light emitting part 23A shown in FIG. 5 is not illustrated, but is substantially identical to that of the second position-determining block 24B shown in FIG. 6. Also in the first position-determining block 24A, a first laser unit 27A is attached to a closed end of a light path 26A (not illustrated) formed in the first position-determining block 24A. A collimating lens 28A (not illustrated) is contained in the light path 26A, and the collimating lens 28A converts a laser light flux emitted by the first laser unit 27A into a collimated light flux B1 having a rectangular cross section whose longer sides are directed in the horizontal direction (i). A translucent cover 29A (not illustrated) is provided at an opened end of the light path 26A.

As shown in FIGS. 3 and 4, a heat radiating cooling section 37 that radiates heat emitted by the first laser unit 27A and the second laser unit 27B is provided in the phase modulating section 20A.

The laser unit 27A of the first light emitting part 23A and the laser unit 27B of the second light emitting part 23B emit laser light having different wavelengths. In the image processing apparatus 10 according to the embodiment, the wavelength of the collimated light flux B1 emitted by the first light emitting part 23A is 642 nm that is a wavelength red light, and the wavelength of the collimated light flux B1 emitted by the second light emitting part 23B is 515 nm that is a wavelength of green light.

In view of this, in the following description, a collimated light flux obtained from the first light emitting part 23A is given a reference sign B1r, and a collimated light flux obtained from the second light emitting part 23B is given a reference sign B1g.

As shown in FIG. 5, a position-determining holding section 22B is formed so as to be integral with the reference base 22, and a phase modulating array 31 is held inside a holding frame 22C that is formed on the position-determining holding section 22B. Since both of the position-determining reference surface 22A that determines the positions of the first light emitting part 23A and the second light emitting part 23B and the holding frame 22C are formed on the reference base 22 so as to be integral with each other, the collimated light flux B1r and the collimated light flux Big emitted by the first light emitting part 23A and the second light emitting part 23B, respectively, can be caused to enter an optical surface 31a of the phase modulating array 31 at optimum incident angles.

The phase modulating array 31 is liquid crystal on silicon (LCOS). The LCOS is a reflective panel having a liquid crystal layer and an electrode layer made of a material such as aluminum. The LCOS, in which electrodes that give an electric field to the liquid crystal layer are regularly disposed, is made up of a plurality of pixels. A collapsing angle of liquid crystals in the liquid crystal layer in a thickness direction of the liquid crystal layer changes depending on a change in the intensity of the electric field given to the electrodes, and the phase of reflected laser light is changed for each pixel.

As shown in FIGS. 3 and 4, a heat radiating cooling section 38 that radiates heat generated by the phase modulating array 31 is provided in the phase modulating section 20A.

As shown in FIG. 5, the collimated light flux B1r that has been converted by the collimating lens 28A in the first light emitting part 23A is supplied to a lower region of the phase modulating array 31, and the collimated light flux B1r that has been converted by the collimating lens 28B in the second light emitting part 23B is supplied to an upper region of the phase modulating array 31. In the phase modulating array 31, the region to which the collimated light flux B1r is supplied is a first conversion region M1, and the region to which the collimated light flux Big is supplied is a second conversion region M2.

Since the cross sections of the collimated light flux B1r and the collimated light flux B1g are rectangular, the first conversion region M1 and the second conversion region M2 are also rectangular. A relative position of the first light emitting part 23A and the second light emitting part 23B in the vertical direction (ii) is adjusted on the reference base 22 so that the first conversion region M1 and the second conversion region M2 do not overlap each other.

The collimated light flux B1r supplied to the first conversion region M1 passes through each of the plurality of pixels of the phase modulating array 31, and thus the phase of the first conversion region M1 is converted. The collimated light flux Big supplied to the second conversion region M2 also passes through each of the plurality of pixels, and thus the phase of the collimated light flux Big is converted. As shown in FIG. 6, a modulated light flux B2 reflected from the phase modulating array 31 becomes interfering light beams that interfere with each other by passing through the respective pixels. This interfering light beams include interference among light components of the red collimated light flux B1r, interference among light components of the green collimated light flux B1g, and interference among the light components of the collimated light flux B1r and the light components of the collimated light flux B1g.

As shown in FIG. 3, a lens holder 32 is provided in the phase modulating section 20A. The position of the lens holder 32, which is fixed on the reference base 22, is determined on the reference base 22. A light focusing lens (Fourier transform lens: FT lens) 33 is held by the lens holder 32. The modulated light flux B2 that has been reflected by the phase modulating array 31 is focused by passing through the light focusing lens 33 and Fourier-transformed into a modulated light flux B3 by the light focusing lens 33.

As shown in FIG. 3, a light delivering mirror 34 held by a mirror holding section 34a is provided in the phase modulating section 20A. The light delivering mirror 34 is a planar mirror, and an optical axis of the light focusing lens 33 enters a reflection surface of the light delivering mirror 34 at a predetermined angle. The modulated light flux B3 that has been Fourier-transformed by the light focusing lens 33 is reflected by the light delivering mirror 34, and a modulated light flux B4 thus reflected travels inside the optical unit 20 and is then supplied to the hologram forming section 20B.

### Hologram Forming Section 20B

As shown in FIG. 3, a first intermediate mirror 35 held by a mirror holding section 35a and a second intermediate mirror 36 held by a mirror holding section 36a are provided in the hologram forming section 20B. The first intermediate mirror 35 and the second intermediate mirror 36 are planar mirrors. As shown in FIG. 4, a reflection surface of the first intermediate mirror 35 faces a reflection surface of the light delivering mirror 34 provided in the phase modulating section 20A. Furthermore, the reflection surface of the first intermediate mirror 35 faces a reflection surface of the second intermediate mirror 36 at a predetermined angle. In the hologram forming section 20B, a screen 51 is disposed in a direction toward which light is reflected by the reflection surface of the second intermediate mirror 36.

As shown in FIG. 4, the modulated light flux B4 reflected by the light delivering mirror 34 travels inside the case in the rightward direction in FIG. 4, and is then reflected by the first intermediate mirror 35. A modulated light flux B5 thus reflected is reflected by the second intermediate mirror 36. Then, a modulated light flux B6 thus reflected by the second intermediate mirror 36 is supplied to the screen 51.

In the phase modulating array 31, the phase of red laser light is converted for each pixel in the first conversion region M1, and the phase of green laser light is converted for each pixel in the second conversion region M2. Light in which interfering light of the red laser light and interfering light of the green laser light are mixed is focused and Fourier-transformed by the light focusing lens 33. Then, the modulated light fluxes B3, B4, B5 and B6 travel through the light path in the case and is then supplied to the screen 51. This forms a hologram image on the screen 51.

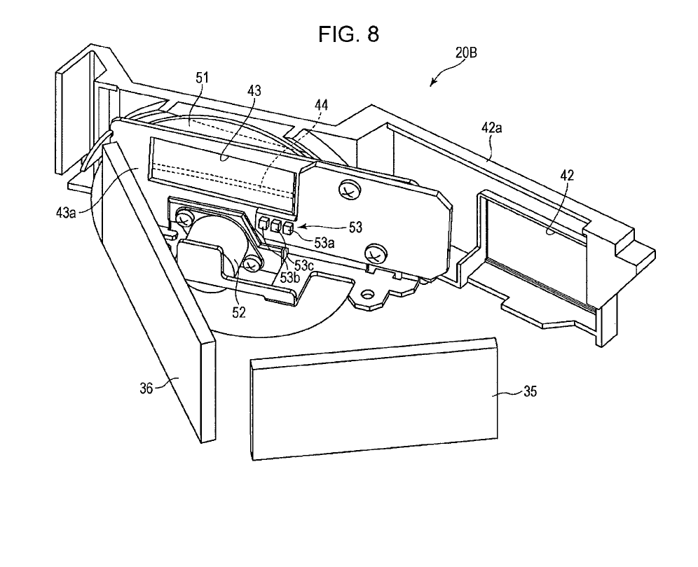

Apertures are formed in plural stages on the light path from the light focusing lens 33 to the screen 51. As shown in FIGS. 3 and 4, a light shielding wall 41a is provided at a portion where light from the phase modulating section 20A exits, and a first aperture 41 that has a rectangular shape is opened in the light shielding wall 41a. A light shielding wall 42a is provided at a portion where light enters the hologram forming section 20B, and a second aperture 42 that has a rectangular shape is opened in the light shielding wall 42a. A light shielding wall 43a is provided between the second intermediate mirror 36 and the screen 51, and a third aperture 43 that has a rectangular shape is opened in the light shielding wall 43a. The third aperture 43 is also shown in FIG. 8.

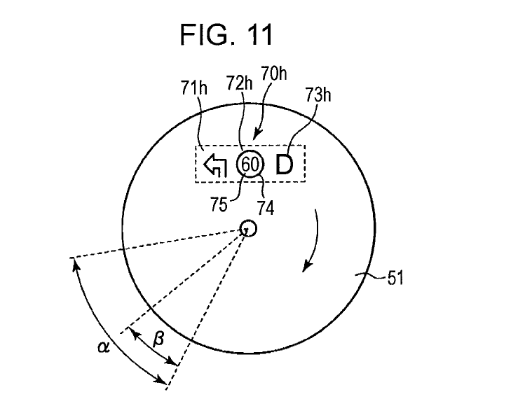

These apertures 41, 42 and 43 provided in three stages block 0-order diffraction light focused onto the screen 51 from the light focusing lens 33. As shown in FIG. 11, a hologram image 70h is formed on the screen 51. This hologram image 70h is generated by first-order diffraction light. Moreover, light components of the first-order diffraction light that do not contribute to formation of the hologram image 70h are blocked by the apertures 41, 42 and 43. Furthermore, higher-order diffraction light such as second-order diffraction light and third-order diffraction light do not contribute to generation of the hologram image 70h and are therefore blocked by the apertures 41, 42 and 43.

That is, only a modulated light flux restricted by aperture areas of the aperture 41, 42 and 43 is supplied to the screen 51, and the hologram image 70h is projected within a range of a restricted area of the screen 51.

As shown in FIG. 8, the screen 51 is disposed ahead (on the light exit side) of the third aperture 43. The screen 51 is a transmissive diffuser (a diffusion plate or a diffusion member) whose surface has a large number of fine concavities and convexities that are randomly formed. Projection light including the hologram image 70h formed on the screen 51 passes through the screen 51 and then becomes projection light B7 which is diverging light. As shown in FIG. 4, the projection light B7 passes through a fourth aperture 44 formed in the light shielding wall 42a, and is then supplied to the projecting section 20C.

As shown in FIGS. 8 and 11, in the hologram forming section 20B, a motor 52 is fixed on the light shielding wall 43a in which the third aperture 43 is opened, and the screen 51 that has a disc shape is rotated at an always constant rotational speed by force of the motor 52. The hologram image 70h becomes diffused light through diffraction by the large number of fine concavities and convexities formed on the screen 51 when passing through the screen 51. Since the fine concavities and convexities have different sizes and are randomly distributed, a light diffusion state of the screen 51 differs from region to region. However, since the screen 51 is rotated, the light diffusion state can be randomized. This makes it possible to reduce speckle noise that is a cause for blurring of the display image 70.

As shown in FIG. 8, in the hologram forming section 20B, a monitor detecting section 53 is provided on the light shielding wall 43a. The monitor detecting section 53 is provided below the third aperture 43. The monitor detecting section 53 is made up of three detecting sections, that is, a red wavelength detecting section 53a, a green wavelength detecting section 53b, and a position detecting section 53c. Each of the detecting sections 53a, 53b and 53c has a light-receiving element such as a pin photodiode that is contained in a closed space thereof and has an opening on the side that faces the second intermediate mirror 36. The opening of the red wavelength detecting section 53a is covered with a wavelength filter that transmits red light, and the opening of the green wavelength detecting section 53b is covered with a wavelength filter that transmits green light.

Each of the detecting sections 53a, 53b and 53c is irradiated with first-order diffraction light or any of higher-order diffraction light other than the first-order diffraction light. The positions of the first light emitting part 23A, the second light emitting part 23B, and the other optical parts are adjusted on the basis of detection output of the position detecting section 53c. Moreover, light emission intensities of the first laser unit 27A and the second laser unit 27B are automatically adjusted and the phase modulating operation of the phase modulating array 31 is also automatically controlled on the basis of detection output of the red wavelength detecting section 53a and the green wavelength detecting section 53b.

### Projecting Section 20C

As shown in FIGS. 3 and 4, in the projecting section 20C, a first projection mirror 55 and a second projection mirror 56 are provided so as to face each other. A reflection surface 55a of the first projection mirror 55 and a reflection surface 56a of the second projection mirror 56 are concave mirrors (magnifying mirrors). The projection light B7 including the hologram image 70h formed on the screen 51 diverges by the screen 51, and is then supplied to the first projection mirror 55. The hologram image 70h is magnified by the first projection mirror 55, and projection light B8 including the hologram image 70h thus magnified is supplied to the second projection mirror 56. The second projection mirror 56 further magnifies the hologram image 70h. As shown in FIG. 3, projection light B9 reflected by the reflection surface 56a of the second projection mirror 56 becomes a light flux that travels upward, passes through the cover plate 14, and is then projected onto the display region 3a of the windshield 3 as shown in FIG. 1.

As shown in FIG. 2, various kinds of information associated with running of the automobile such as navigation information 71, automobile velocity indication 72, and shift lever position information 73 are displayed in the display image 70. The display image 70 is displayed by red light or green light or displayed by a combination color of red light and green light.

Since the windshield 3 functions as a semi-reflection surface, the display image 70 appears to the driver 5 as if the display image 70 is present at a virtual image 6 formation position ahead of the windshield 3.

In the image processing apparatus 10, zero-order diffraction light focused by the light focusing lens 33 is blocked by the apertures 41, 42 and 43, and the hologram image 70h formed on the screen 51 by the first-order diffraction light is magnified and projected onto the display region 3a. Therefore, even in a case where a person looks into an inside of the cover plate 14 from an outside of the windshield 3, there is no possibility that laser light directly enters the eyes of the person. This secures safety.

### Passage of Light Flux

The image processing apparatus 10 is mounted in the automobile so that the optical base 21 of the optical unit 20 is substantially horizontal. As shown in FIG. 4, all of the optical axes of the collimated light flux B1r and B1g emitted by the first light emitting part 23A and the second light emitting part 23B, the modulated light flux B2 converted by the phase modulating array 31 and the modulated light flux B3 that has passes through the light focusing lens 33 extend horizontally in parallel with the optical base 21. Furthermore, the optical axes of the modulated light flux B4 reflected by the light delivering mirror 34, the modulated light flux B5 reflected by the first intermediate mirror 35, and the modulated light flux B6 reflected by the second intermediate mirror 36 also extend horizontally in parallel with the optical base 21. The optical axis of the projection light B7 that has passed through the screen 51 is also horizontal, and the projection light B8 reflected by the first projection mirror 55 is supplied to the second projection mirror 56 while traveling slightly upward, and the projection light B9 reflected by the second projection mirror 56 is directed upward toward the windshield 3.

Since light fluxes of light components other than the projection light B8 and B9 are directed almost horizontally so as to intersect the upward projection direction of the projection light B9, the image processing apparatus 10 can be made small in thickness. This makes it easy to embed the image processing apparatus 10 in the dashboard 2.

As shown in FIGS. 3 and 4, the modulated light flux B4 that travels from the light delivering mirror 34 to the first intermediate mirror 35 passes between the first projection mirror 55 and the second projection mirror 56, and the projection light B8 that travels from the first projection mirror 55 toward the second projection mirror 56 intersects the modulated light flux B4. By thus causing the light fluxes to intersect each other in the projecting section 20C, it is possible to secure a long light path from the light focusing lens 33 to the screen 51 and to form a hologram image on the screen 51 at a proper magnification. Furthermore, by thus causing the light fluxes to intersect each other in the projecting section 20C, the image processing apparatus 10 can be made small in size even if the light path is long.

As shown in FIG. 4, the direction of the modulated light flux B4 that travels from the light delivering mirror 34 to the first intermediate mirror 35 is reverse to the direction of the modulated light flux B6 that travels from the second intermediate mirror 36 to the screen 51. Furthermore, the direction of the projection light B7 that travels from the screen 51 to the first projection mirror 55 is also reverse to the direction of the modulated light flux B4. By thus causing the light fluxes to travel in reverse directions inside the case, the whole apparatus can be made small in size.

### Control of Driving of Laser Units 27A and 27B and Phase Modulating Array 31

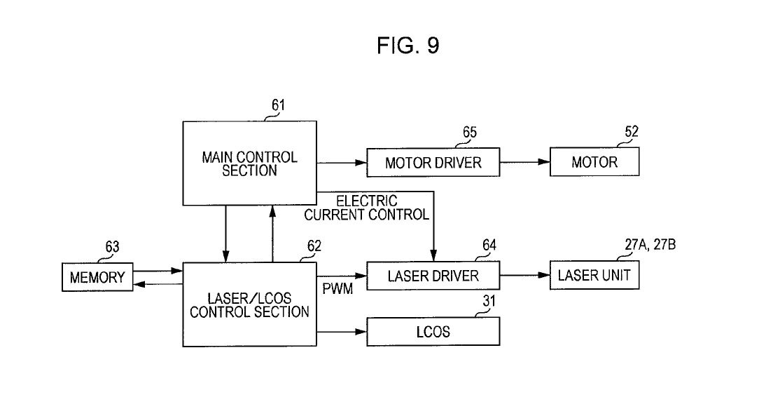

FIG. 9 shows a circuit configuration of the image processing apparatus 10.

The image display device 10 includes a main control section 61 that is mainly constituted by a CPU and a laser/LCOS control section 62 that is controlled by the main control section 61. The main control section 61 monitors and controls the rotational speed of the motor driver 65 so that the motor 52 rotates at an always constant rotational speed and the screen 51 maintains a constant rotational speed.

The main control section 61 controls an electric current supplied to the laser driver 64 and thus controls the light emission intensities of the laser units 27A and 27B. The laser/LCOS control section 62 controls the laser driver 64 and thus controls a duty ratio in pulse width modulation of the laser units 27A and 27B. The phase modulating array 31 is controlled by the laser/LCOS control section 62. The laser units 27A and 27B and the phase modulating array 31 are controlled by the laser/LCOS control section 62, which is a control section common to the laser units 27A and 27B and the phase modulating array 31, so as to be driven in sync with each other.

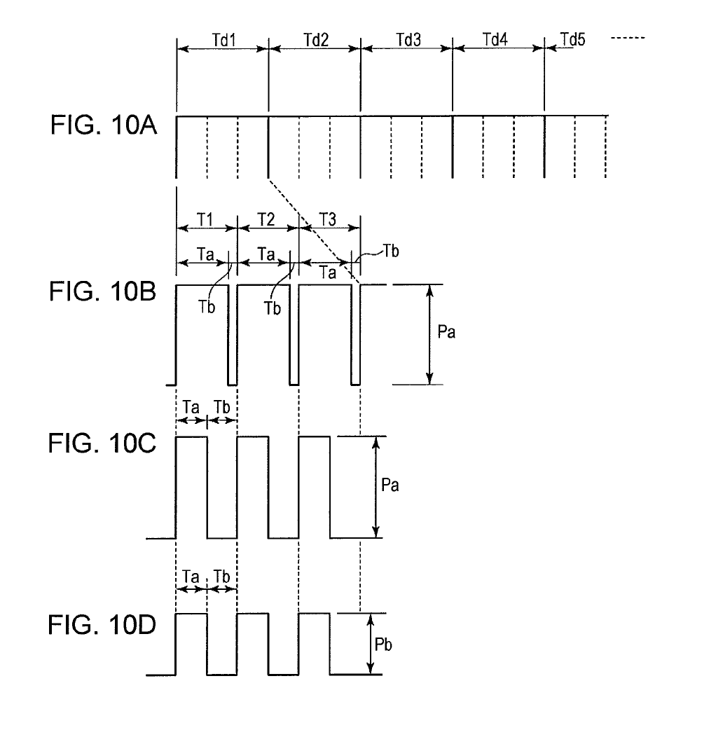

FIGS. 10A through 10D show a light emission timing of laser light from the semiconductor lasers contained in the laser units 27A and 27B. The two laser units 27A and 27B are driven in sync with each other by the main control section 61. The two laser units 27A and 27B emit light at the same timing and stop light emission at the same timing.

FIG. 10A shows unit driving periods Td (Td1, Td2, Td3, Td4, . . . ). Light emission of the laser units 27A and 27B is controlled so that the unit driving periods Td having an identical duration are repeated. As shown in FIG. 10B, a single unit driving period Td is divided into a first divided driving period T1, a second divided driving period T2, and a third divided driving period T3.

The first divided driving period T1 is made up of a light emission period Ta and a non-light emission period Tb that follows this light emission period Ta. Similarly, each of the second divided driving period T2 and the third divided driving period T3 is made up of a light emission period Ta and a non-light emission period Tb that follows this light emission period Ta.

The laser units 27A and 27B are driven by pulse width modulation (PWM), and the duty ratio {Td/(Td+Ts)} of the light emission period Ta can be changed by the control operation of the laser/LCOS control section 62.

In this embodiment, the repetition frequency of the unit driving period Td is 60 Hz. Accordingly, the repetition frequency of the light emission period Ta and the non-light emission period Tb is 180 Hz. In the first divided driving period T1, the second divided driving period T2, and the third divided driving period T3, different items of the hologram image are displayed respectively. Accordingly, the repetition frequency of the first divided driving period T1 in which a single item is displayed is 60 Hz. Similarly, the repetition frequency of the second divided driving period T2 and the repetition frequency of the third divided driving period T3 are 60 Hz.

As shown in FIG. 11, the hologram image 70h is projected onto the screen 51 by first-order diffraction light. The hologram image 70h contains a first item 71h for projecting the navigation information 71 of the display image 70 shown in FIG. 2, a second item 72h for projecting the automobile velocity indication 72, and a third item 73h for projecting the shift level position information 73. The first item 71h, the second item 72h, and the third item 73h shown in FIG. 2 are one example of display form, and other various images can be displayed according to need.

The laser/LCOS control section 62 shown in FIG. 9 drives the phase modulating array 31 so that the phase modulating array 31 is switched in sync with light emission driving control of the laser units 27A and 27B. When a hologram image is generated by the phase modulating array 31, any of plural kinds of image data stored in a memory 62 is selected and read out.

Through spatial phase modulation by the phase modulating array 31, a generated hologram image is switched in sync with a switching point among the divided driving periods, i.e, the first divided driving period T1, the second divided driving period T2, and the third divided driving period T3. That is, display control of the phase modulating array 31 is switched in sync with a ⅓ period of the unit driving period Td.

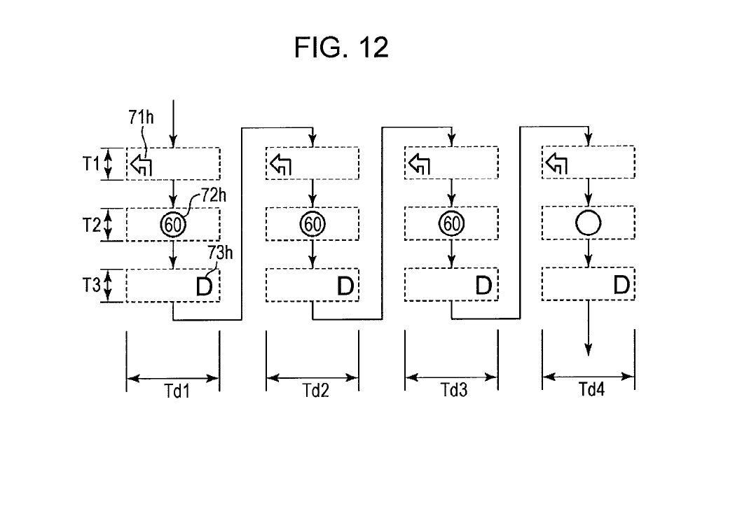

As shown in FIG. 12, in the unit driving period Td1, a hologram image of the first item 71h is generated in the first divided driving period T1, a hologram image of the second item 72h is generated in the second divided driving period T2, and a hologram image of the third item 73h is generated in the third divided driving period T3. Also in each of the unit driving periods Td2, Td3, Td3, . . . , a hologram image of the first item 71h is generated in the first divided driving period T1, a hologram image of the second item 72h is generated in the second divided driving period T2, and a hologram image of the third item 73h is generated in the third divided driving period T3.

Since the unit driving period Td is switched at 60 Hz, the display image 70 displayed in the display region 3a of the windshield 3 based on this hologram image 70h appears to human eyes as if the navigation information 71, the automobile velocity indication 72, and the shift level position information 73 are concurrently displayed.

In the image processing apparatus 10, the main control section 61 controls the motor driver 65 to drive the motor 52. This rotates the screen 51 at 3600 rpm. The screen 51 rotates 60 times per second. Since the unit driving period Td is switched at 60 Hz, the screen 51 rotates one time in 1 unit driving period Td.

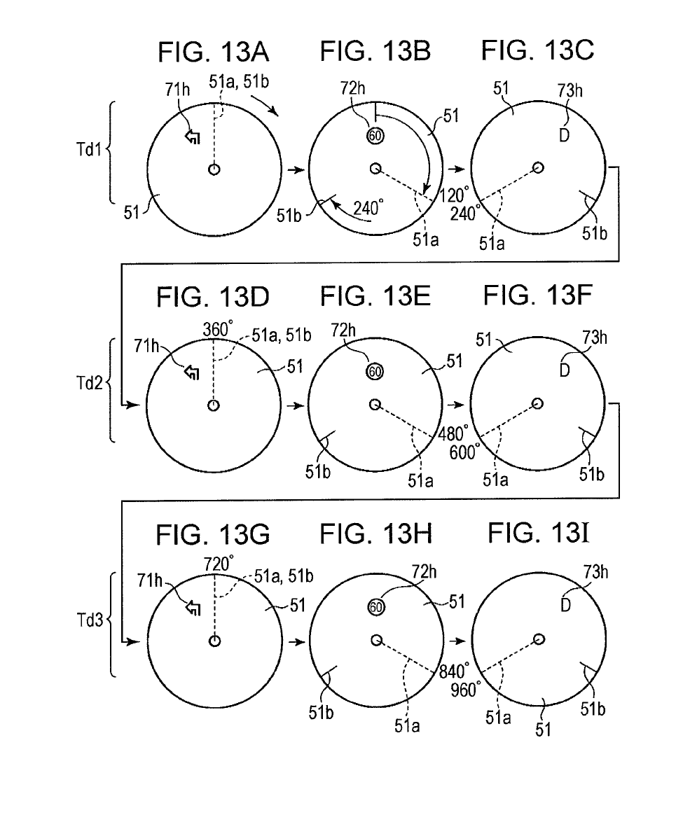

FIGS. 13A through 13I show rotation angles of the screen 51 and an operation of switching a hologram image projected on the screen 51 in the divided driving periods T1, T2 and T3. In FIG. 13A through 13I, an angle reference 51a is shown on the screen 51. This angle reference 51a is for explaining a rotation angle of the screen 51, and the angle reference 51a is not shown on the actual screen 51.

Since each of the divided driving periods T1, T2 and T3 is ⅓ of the unit driving period Td, hologram images of the items 71h, 72h and 73h are projected on respective 120 degrees regions of the screen 51 during 1 rotation of the screen 51. To be precise, any one of the items 71h, 72h and 73h is projected in a 120 degrees region in a laser light source light emission period Ta of each divided driving period. That is, the maximum rotation angle of the screen 51 during projection of a hologram image of one item on the screen 51 is 120 degrees.

As shown in FIG. 13A, in the first divided driving period T1 of the unit driving period Td1, the screen 51 rotates by 120 degrees at maximum while the hologram image of the first item 71h is projected on the screen 51. As shown in FIG. 13B, in the second divided driving period T2 of the unit driving period Td1, the screen 51 rotates by 120 degrees at maximum while the hologram image of the second item 72h is projected on the screen 51. As shown in FIG. 13C, in the third divided driving period T3 of the unit driving period Td1, the screen 51 rotates by 120 degrees at maximum while the hologram image of the third item 73h is projected on the screen 51.

As shown in FIGS. 13D, 13E, 13F, . . . , a hologram image is also switched in a similar manner in the unit driving periods Td2, Td3, . . . .

When the first item 71h, the second item 72h, and the third item 73h are projected, light containing display contents of these items 71h, 72h and 73h is diffused by the fine concavities and convexities of the screen 51, and is then supplied as the projection light B7 to the projection section 20C. Since the fine concavities and convexities on the screen 51 are randomly formed, a diffusion condition of a hologram image differs from place to place on the screen 51. However, since the screen 51 rotates by 120 degrees at maximum while the hologram images of the items 71h, 72h and 73h are diffused, the variation in the diffusion condition is randomized. This reduces speckle noise that is a cause for blurring of a hologram image.

As shown in FIGS. 13A, 13D and 13G, in the unit driving periods Td, the rotation phase (rotation position) of the screen 51 at the start (start of the light emission period Ta) of projection of the hologram image of the first item 71h on the screen 51 is always the same. Accordingly, the position on the screen 51 at which projection of the hologram image is started at the time of FIG. 13A and an angular region (angular range) on the screen 51 in which the hologram image is projected while the screen 51 rotates by 120 degrees at maximum are the same as those in a case where the hologram image of the first item 71h is projected at the time of FIGS. 13D and 13G.

In the unit driving periods Td1, Td2, Td3, . . . , projection of the first item 71h always starts from an identical position on the screen 51, and the first item 71h is then projected in an identical angular region of the screen 51. Accordingly, the diffusion condition on the screen 51 can be always made uniform among projection periods in which the hologram image of the first item 71h is repeatedly projected. It is therefore possible to reduce flicker noise, i.e., flickering of display of the navigation information 71 shown in FIG. 2 that is caused by PWM driving of laser light.

As shown in FIGS. 13B, 13E and 13H, the projection start position on the screen 51 at the start of projection of the hologram image of the second item 72h is also always the same, and an angular region (angular range) in which the hologram image of the second item 72h is projected on the screen 51 is also always the same. As shown in FIGS. 13C, 13F and 13I, the same also applies to projection of the hologram image of the third item 73h.

As described above, in a case where the switching frequency (60 Hz) of each of the divided driving periods T1, T2 and T3 corresponds to the rotational speed of the screen 51 one to one, it is possible to always start projection of a hologram image of an identical item from the same position on the screen 51.

FIGS. 13A through 13I show an angle reference 51b on the screen 51 obtained in a case where the frequency of the unit driving period Td is 60 Hz (the switching frequency of each of the divided driving periods T1, T2 and T3 is 60 Hz) and the rotational speed of the screen 51 is 7200 rpm, which is twice that of the above embodiment.

When the rotational speed of the screen 51 doubles, the screen 51 rotates by 240 degrees at maximum while the hologram image of the first item 71h is projected. Similarly, the screen 51 rotates by 240 degrees at maximum while the hologram image of the second item 72h is projected and while the hologram image of the third item 73h is projected. In this example, since the rotation angle of the screen 51 during projection of one item is twice that of the above embodiment, it is possible to increase the effect of randomizing the diffusion condition on the screen. It is therefore possible to further improve speckle noise.

Moreover, in each of the unit driving periods Td, a position where the hologram image of the first item 71h is formed at the start of the projection of the hologram image of the first item 71h and a subsequent angular region are always the same positions on the screen 51. The same also applies to projection of the hologram image of the second item 72h and projection of the hologram image of the third item 73h.

As shown in FIGS. 13A through 13I, in a case where N is the integral multiple of M where N is the rotational speed of the screen 51 per unit time and M is the repetition number of light emission period Ta for displaying an identical hologram image (e.g., the light emission period Ta of the first divided driving period T1) per the unit time, projection of the hologram image displaying an identical item can be started from the same position on the screen 51. In the above example, N is 3600 rpm or 7200 rpm, and the repetition number of light emission periods Ta in each of the divided driving periods T1, T2 and T3 per minute is 3600.

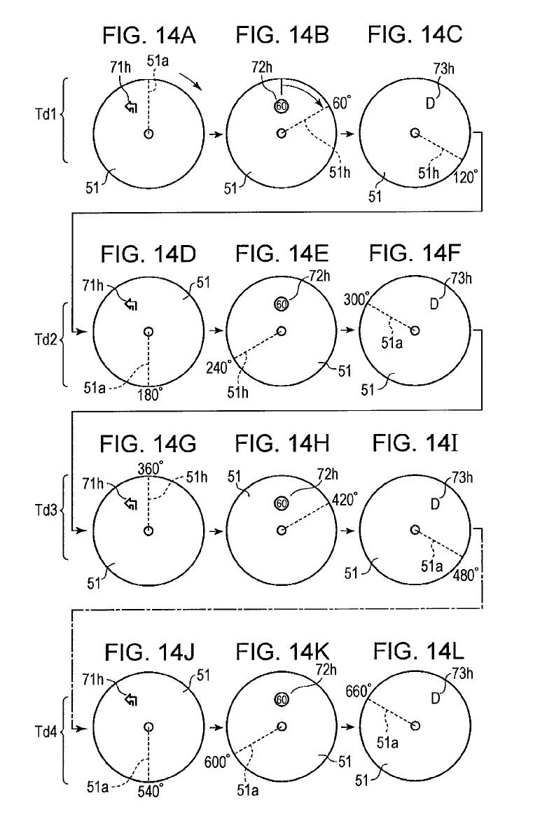

FIGS. 14A through 14L, FIGS. 15A through 15L, and FIGS. 16A through 16L show driving methods according to other embodiments.

In the example shown in FIGS. 14A through 14L, the switching frequency of the unit driving period Td is 60 Hz, which is the same as that of the above embodiment, but the rotational speed of the screen 51 is 1800 rpm, which is ½ of that of the above embodiment. That is, N is ½ of M.

In this example, a hologram image of any of the first item 71h, the second item 72h and the third item 73h is projected while the screen 51 rotates by 60 degrees.

In FIGS. 14A and 14G, projection of the hologram image of the first item 71h starts from the same position on the screen 51. In FIGS. 14D and 14J, projection of the hologram image of the first item 71h starts from the same position on the screen 51. That is, there are two positions on the screen 51 from which projection of the hologram image of the first item 71h is started at the start of the light emission period Ta. The same also applies to display timings of the second item 72h and the third item 73h.

In this embodiment, since projection of an identical hologram image of the item 71h, 72h or 73h always starts from two positions on the screen 51, a change of a randomized diffusion condition in displaying the identical hologram image can be limited to two patterns. It is therefore possible to improve flicker noise.

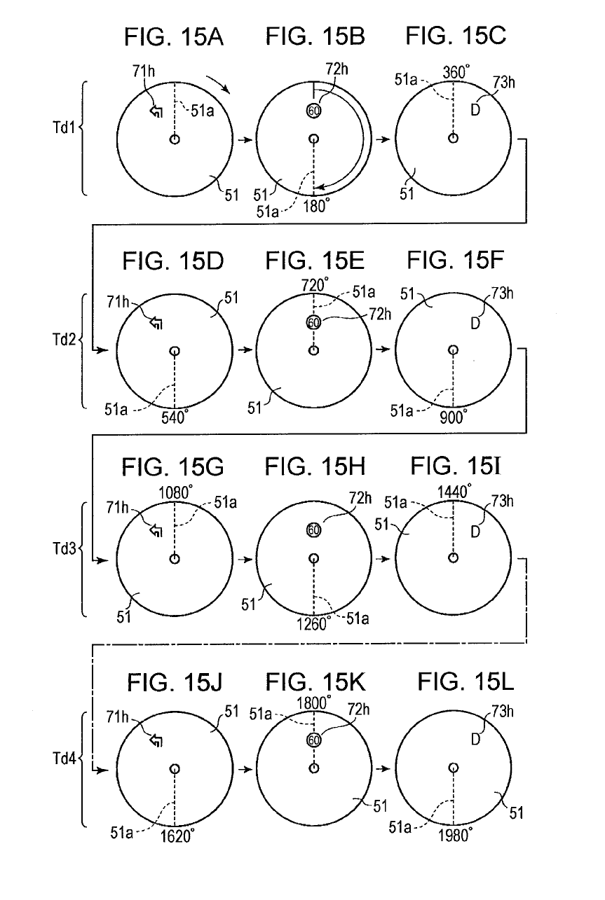

In the example shown in FIGS. 15A through 15L, the switching frequency of the unit driving period Td is 60 Hz, which is the same as that of the above embodiment, but the rotational speed of the screen 51 is 5400 rpm, which is 3/2 of that of the above embodiment. That is, N is 3/2 of M.

In this example, a hologram image of any of the first item 71h, the second item 72h and the third item 73h is projected while the screen 51 rotates by 180 degrees.

In FIGS. 15A and 15G, projection of the hologram image of the first item 71h starts from the same position on the screen 51. In FIGS. 15D and 15J, projection of the hologram image of the first item 71h starts from the same position on the screen 51. That is, there are two positions on the screen 51 from which projection of the hologram image of the first item 71h starts at the start of the light emission period Ta. The same also applies to display timings of the second item 72h and the third item 73h.

Also in this embodiment, since projection of the hologram image of the item 71h, 72h or 73h always starts from two positions on the screen 51, a change of a randomized diffusion condition in displaying the identical hologram image can be limited to two patterns. It is therefore possible to improve flicker noise.

According to FIGS. 14A through 14L and FIGS. 15A through 15L, in a case where N=(n/2) M (n is an integer excluding 2 and multiple numbers of 2), the number of positions on the screen 51 where an identical hologram image is projected at the start of the light emission period Ta can be limited to two.

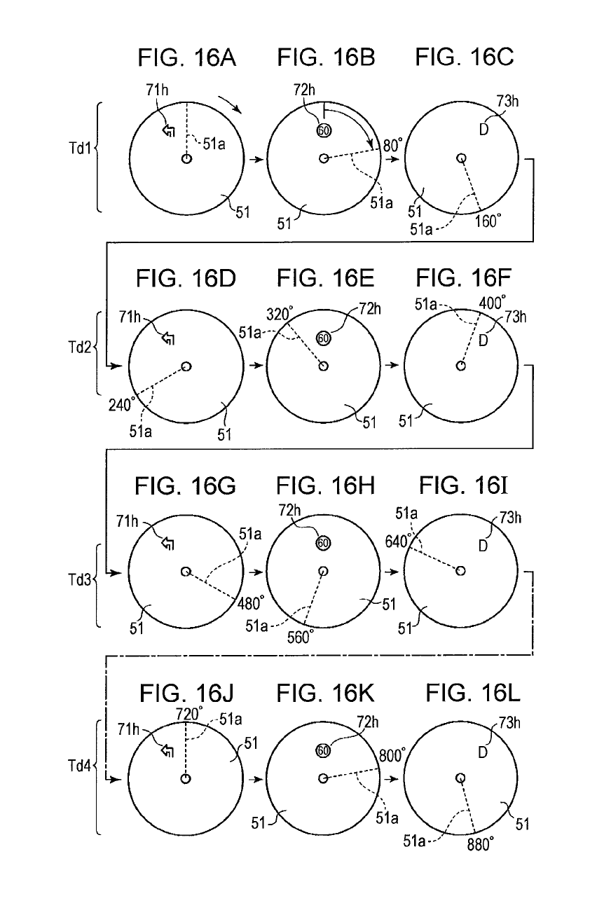

Next, in the example shown in FIGS. 16A through 16L, the switching frequency of the unit driving period Td is 60 Hz, which is the same as that of each of the above embodiments, but the number of rotations of the screen 51 is 2400 rpm, which is ⅔ of that of each of the above embodiments. That is, N is ⅔ of M.

In this example, a hologram image of any of the first item 71h, the second item 72h and the third item 73h is projected while the screen 51 rotates by 80 degrees.

In FIGS. 16A, 16D and 16G, projection of the hologram image of the first item 71h starts from different positions on the screen 51. However, in FIGS. 16A and 16J, projection of the hologram image of the first item 71h starts from the same position on the screen 51. That is, when projection of a hologram image of the item 71h, 72h or 73h starts, projection of an identical hologram image starts from any of the three positions on the screen 51. In this embodiment, a randomized diffusion condition in displaying an identical hologram image can be limited to three patterns. It is therefore possible to improve flicker noise.

According to FIGS. 16A through 16L, in a case where N=(n/3) M (n is an integer excluding 3 and multiple numbers of 3), the number of positions on the screen 51 where an identical hologram image is projected at the start of the light emission period Ta can be limited to three.

By thus limiting positions on a screen where projection of an identical hologram image starts at the start of each light emission period Ta to three or less, it is possible to improve flicker noise. Note, however, that the positions where projection of an identical hologram image starts is preferably limited to 2 or less positions on the screen 51, more preferably 1 position as shown in FIGS. 13A through 13I.

In a case where an image of hologram 70h is generated, image data corresponding to the hologram image is read out from the memory 63, and the phase modulating array 31 modulates the phases of the collimated light fluxes B1r and Big on the basis of the image data thus read out.

FIG. 11 shows an example of a display image of the hologram image 70h. In this example, the first item 71h is for displaying the navigation information 71, and a display state of the first item 71h changes depending on a running state of an automobile. For generation of the hologram image of the first item 71h, image data corresponding to plural kinds of arrow images that indicate different directions are stored in the memory 63. The laser/LCOS control section 62 selects and reads out image data of any of the arrows, and controls driving of the phase modulating array 31 on the basis of the image data thus read out.

The second item 72h shown in FIG. 11 is for the automobile velocity indication 72. The hologram image of the second item 72h is made up of a combination of a display element 74 representing a round frame that does not change irrespective of a running state and a display element 75 that is located inside the round frame and changes depending on a change of the running speed. The phase modulating array 31 generates the hologram image so that the round frame that is the display element 74 is always displayed. Moreover, image data concerning the display element 75 such as “60” or “59” is read out depending on a change of the speed, and the hologram image is generated by the phase modulating array 31 on the basis of the image data thus read out.

The third item 73h shown in FIG. 11 is a display element for displaying the shift level position information 73. Image data such as “D”, “R” and “P” are stored in the memory 63, any of the image data is read out depending on the change of the shift lever position, and a hologram image of the third item 73h is generated by the phase modulating array 31 on the basis of the image data thus read out.

Since in the hologram image 70h shown in FIG. 11, the second item 72h for the velocity indication 72 is a combination of the display element 74 that does not change and the display element 75 that changes from moment to moment, the display element 74 can be continuously displayed without the need to switch the image data. It is therefore possible to reduce the load of the control operation of the laser/LCOS control section 62. Furthermore, the numeral display of the second item 72h, the arrow display of the first item 71h, and the position display of the third item 73h can be generated by image data corresponding to a pattern of a predetermined character and a sign such as “←”, “↑”, “→”, “60”, “59”, “58”, “D”, “R” and “P”. It is therefore only necessary to store data of these image patterns for displaying the display elements. Consequently, it is possible to reduce the load of the control operation of the laser/LCOS control section 62.

In this image processing apparatus 10, the hologram display image 70 is displayed in the display region 3a of the windshield 3 as shown in FIG. 2, but the luminance of this display image need be changed depending on the environment. The luminance of the display image 70 need be increased during running at daytime, whereas the luminance of the display image 70 need be lowered in darkness.

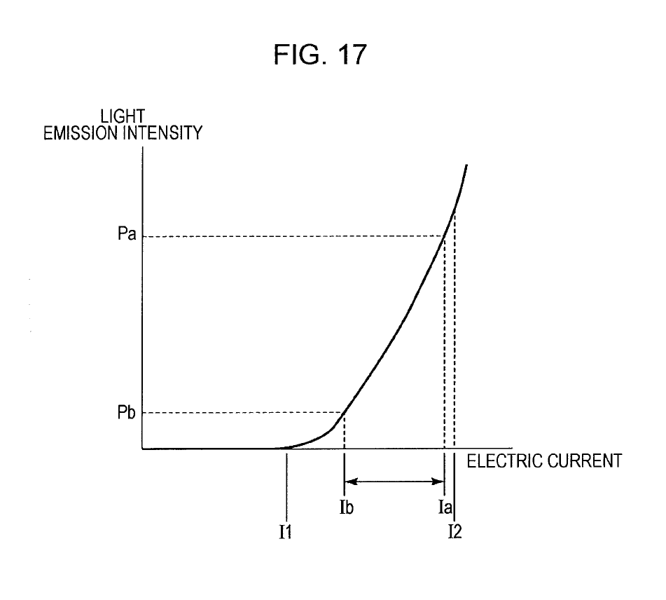

FIG. 17 schematically shows a relationship between the amount of electric current supplied to the semiconductor laser and the light emission intensity. As the amount of electric current supplied to the semiconductor layer gradually increases, the light emission intensity is low at first but becomes high when the amount of electric current becomes a certain degree of value (I1), and after that, the light emission intensity becomes higher as the amount of electric current becomes larger. However, the width of change (I1 to I2) of the electric current value in increasing the light emission intensity is relatively small.

In view of this, when the luminance of the display image is changed, a duty ratio {Ta/(Ta+Tb)} of light emission of the semiconductor lasers in the laser units 27A and 27B is changed. The duty ratio is controlled by the laser/LCOS control section 62.

When FIGS. 10B and 10C are compared, the duty ratio is low in FIG. 10C. This reduces the luminance of the hologram image 70h projected on the screen 51, and therefore reduces the luminance of the display image 70 shown in FIG. 2.

However, when the duty ratio is reduced from that of FIG. 10B to that of FIG. 100, the light emission period Ta in each of the divided driving periods T1, T2 and T3 becomes short. In a case where the light emission period Ta becomes shorter from that of FIG. 10B to that of FIG. 100, the rotation angle of the screen 51 during projection of the hologram image is reduced, for example, from the angular range α to the angular range β in FIG. 11. When the rotation angle of the screen 51 during projection of the hologram image becomes small, the diffusion function of the screen 51 cannot be sufficiently randomized. This increases the ratio of occurrence of speckle noise.

In view of this, in the image processing apparatus 10 according to the embodiment, after the duty ratio is reduced to some degree, the amount of electric current applied to the semiconductor lasers is reduced from Ia to Ib by the control operation of the main control section 61. This reduces the luminance of the hologram image 70h without reducing the duty ratio. In this way, the luminance of the display image 70 shown in FIG. 2 is reduced.

As shown in FIG. 17, a dynamic range (I1 to I2) in which the electric current value can be changed with respect to light emission of the semiconductor lasers is small, the amount of electric current is set to Ia at first that is close to the maximum value so that the light emission intensity is set to Pa. The luminance of the display image 70 is changed by changing the duty ratio {Ta/(Ta+Tb)}. After the duty ratio is reduced to some degree, the electric current value is reduced from Ia to Ib in stages without changing the duty ratio so that the light emission intensity is reduced to Pb. Thus, the luminance is reduced.

This control method can increase the substantial dynamic range in which the luminance of the display image 70 can be changed. Moreover, it is possible to prevent the duty ratio from becoming extremely low, thereby reducing speckle noise caused by intermittent light emission.

What is claimed is:

1. An image processing apparatus comprising:
a laser light source;
a screen that provides light diffusion; and
a phase modulating array that modulates a phase of laser light emitted by the laser light source and forms a hologram image on the screen,
the screen being rotated at a certain rotational speed by a motor,
light emission of the laser light source being controlled so that a light emission period and a non-light emission period following the light emission period are repeated, and
luminance of the hologram image being changed by changing a duty ratio of the light emission period, and after the duty ratio is reduced to a predetermined value, the luminance of the hologram image being reduced by reducing light emission intensity of the laser light emitted by the laser light source.

2. The image processing apparatus according to claim 1, wherein the laser light source comprises a semiconductor laser.

3. The image processing apparatus according to claim 1, further comprising a projection section that projects a hologram image onto the screen.

4. The image processing apparatus according to claim 3, wherein the projection section projects the hologram image onto a display region of a windshield of an automobile.

5. The image processing apparatus according to claim 4, wherein, in darkness, the luminance of the hologram image is reduced by reducing the light emission intensity of the laser light emitted by the laser light source.
